(19) United States
(12) Patent Application Publication
(10) Pub. No.: US 2019/0057457 A1
(43) Pub. Date: Feb. 21, 2019

(54) SYSTEMS AND METHODS FOR PROVIDING PAGE STATUS CARDS ASSOCIATED WITH TRANSACTIONS FOR PAGES IN A SOCIAL NETWORKING SYSTEM

(71) Applicant: Facebook, Inc., Menlo Park, CA (US)

(72) Inventors: Zhonghu Gao, Fremont, CA (US); Yuanying Deng, Sunnyvale, CA (US)

(21) Appl. No.: 15/678,018

(22) Filed: Aug. 15, 2017

(51) Int. Cl. G06Q 50/00; G06Q 50/12; G06Q 30/06; G06Q 10/02

(52) U.S. Cl. CPC G06Q 50/01; G06Q 50/12; G06K 19/06037; G06Q 10/02; G06Q 30/0633

(57) ABSTRACT

Systems, methods, and non-transitory computer readable media can provide a workflow associated with a page of a social networking system. A page can be generated in response to completion of the workflow by a user. The page status card can be provided for display on the page.

### FIELD OF THE INVENTION

The present technology relates to the field of social networking systems. More particularly, the present technology relates to techniques for providing status cards for pages associated with social networking systems.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

The social networking system may provide pages for various entities. For example, pages may be associated with companies, businesses, brands, products, artists, public figures, entertainment, individuals, and other types of entities. Pages can be dedicated locations provided by the social networking system to reflect the presence of the entities on the social networking system.

### SUMMARY

Various embodiments of the present disclosure can include systems, methods, and non-transitory computer readable media configured to provide a workflow associated with a page of a social networking system. A page can be generated in response to completion of the workflow by a user. The page status card can be provided for display on the page.

In some embodiments, a plurality of page status cards associated with the user can be ranked, and the plurality of page status cards can be provided for display on the page in an order of the ranking.

In certain embodiments, the ranking the plurality of page status cards is based on a machine learning model.

In an embodiment, the workflow includes one or more of: a delivery workflow, a reservation workflow, or a ticketing workflow.

In some embodiments, an expiration of the page status card can be determined, wherein the page status card is no longer provided for display on the page after the expiration of the page status card.

In certain embodiments, content of the page status card includes one or more of: a title, a description, a call-to-action (CTA), a user interface (UI) element for accessing additional details associated with the page status card, or media content.

In an embodiment, the content of the page status is dynamically determined.

In some embodiments, a format of the page status card is specified by an application programming interface (API).

In certain embodiments, the page status card can be provided on a profile of the user.

In an embodiment, the page status card is shared by the user with at least one connection of the user, and the page status card is provided in a feed of the at least one connection of the user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example page status card module configured to provide page status cards, according to an embodiment of the present disclosure.

FIG. 2 illustrates an example page status card generation module configured to generate page status cards, according to an embodiment of the present disclosure.

FIG. 3A illustrates an example user interface for providing page status cards, according to an embodiment of the present disclosure.

FIG. 3B illustrates an example user interface for providing page status cards, according to an embodiment of the present disclosure.

FIG. 3C illustrates an example page status card unit for providing page status cards, according to an embodiment of the present disclosure.

FIG. 4 illustrates an example first method for providing page status cards, according to an embodiment of the present disclosure.

FIG. 5 illustrates an example second method for providing page status cards, according to an embodiment of the present disclosure.

FIG. 6 illustrates a network diagram of an example system that can be utilized in various scenarios, according to an embodiment of the present disclosure.

FIG. 7 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Providing Page Status Cards Associated with Transactions for Pages in a Social Networking System

People use computing devices (or systems) for a wide variety of purposes. Computing devices can provide different kinds of functionality. Users can utilize their computing devices to produce information, access information, and share information. In some cases, users can utilize computing devices to interact or engage with a conventional social networking system (e.g., a social networking service, a social network, etc.). A social networking system may provide resources through which users may publish content items. In one example, a content item can be presented on a profile page of a user. As another example, a content item can be presented through a feed of a user.

The social networking system may provide pages for various entities. For example, pages may be associated with companies, businesses, brands, products, artists, public figures, entertainment, individuals, and other types of entities. Pages can be dedicated locations on the social networking system to reflect the presence of the entities on the social networking system. Under conventional approaches specifically arising in the realm of computer technology, an entity can provide various functionalities associated with products or services through an associated page, and a user can enter into transactions with the entity via the page. For example, a user may purchase products or make appointments through the entity's page. However, conventional approaches do not provide information about a user's transactions with a particular page in a user-friendly manner. Rather, information about a user's transactions can be difficult to find and access. For example, a user may have to perform involved and cumbersome navigation in order to view transactions with various pages.

An improved approach rooted in computer technology can overcome the foregoing and other disadvantages associated with conventional approaches specifically arising in the realm of computer technology. Based on computer technology, the disclosed technology can provide page status cards for transactions between a user and a page. For example, page status cards can be provided on an associated page. A page status card can be created for a transaction between a user and a page, and can be provided in a user interface for displaying the page. A page can provide various types of workflows, such as a reservation workflow, a delivery workflow, a ticketing workflow, etc. After a user completes a workflow provided by a page, a transaction can be created, and a page status card can be created for the transaction. In some embodiments, content of a page status card can include a title, a description, a user interface element (e.g., a button) for accessing additional details, and a call-to-action. The content of a page status card can vary based on the type of workflow associated with the page status card. The content of a page status card can be selected or updated dynamically, for example, based on a status of a corresponding transaction, a time of an event associated with a corresponding transaction, etc. In some embodiments, page status cards can be ranked based on machine learning techniques. In certain embodiments, page status cards can expire and may no longer be displayed after a time period, an event, etc. In this manner, the disclosed technology can provide information about a user's transactions on a page at a glance, for example, in a way that is easy to understand for the user. Details relating to the disclosed technology are provided below.

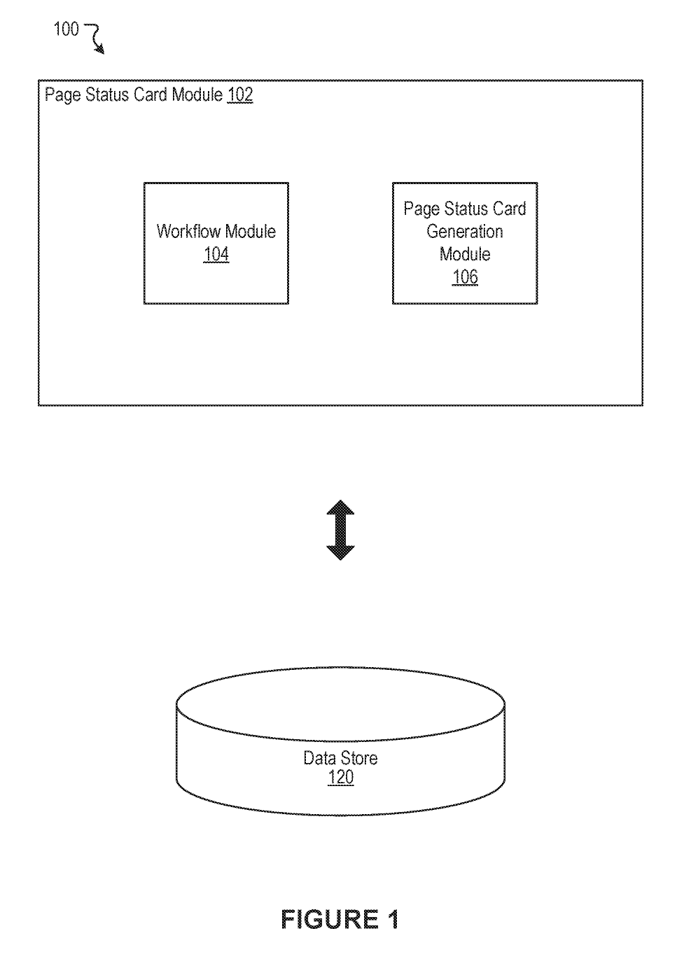

FIG. 1 illustrates an example system 100 including an example page status card module 102 configured to provide page status cards, according to an embodiment of the present disclosure. The page status card module 102 can include a workflow module 104 and a page status card generation module 106. In some instances, the example system 100 can include at least one data store 120. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the page status card module 102 can be implemented in any suitable combinations. While the disclosed technology is described in connection with page status cards for pages associated with a social networking system for illustrative purposes, the disclosed technology can apply to any other type of system and/or content.

The workflow module 104 can provide various workflows associated with pages. In some embodiments, an entity associated with a page can define a workflow associated with the page. In other embodiments, a third party, such as a partner associated with an entity or a social networking system, can define a workflow associated with a page. Any type of workflow can be supported. Examples of types of workflows can include a reservation or appointment workflow, a delivery or ordering workflow, a ticketing workflow, etc. A workflow can be defined according to requirements of a page. A workflow can vary based on products and/or services associated with the workflow. As an example, a reservation workflow for a restaurant and a reservation workflow for an airplane flight can be different. As another example, a delivery workflow for food and a delivery workflow for non-food products can be different. A workflow can be initiated in response to a selection by a user of a user interface (UI) element provided on a page. Examples of UI elements can include buttons, icons, links, etc. In some embodiments, the UI element can be a CTA associated with a page. After a workflow is completed by a user, a transaction can be created for the completed workflow. A page status card can be created for the transaction. The user who completed the workflow can be associated with the transaction and the page status card.

In some embodiments, the workflow module 104 can provide, for example, a food delivery workflow. As an example, the food delivery workflow can provide a menu and a list of items that can be ordered. A user can select items to order and indicate a delivery time. The user can enter an address and contact information for the delivery. The user can also enter payment information. The food delivery workflow can be completed after a payment is successfully made. A transaction can be created for the completed workflow, and a page status card can be created for the transaction.

In certain embodiments, the workflow module 104 can provide, for example, a restaurant reservation workflow. As an example, the restaurant reservation workflow can provide available dates and times for a reservation with a restaurant. A user can select a date and time for a reservation. The user can enter contact information. The restaurant reservation workflow can be completed if the reservation is successfully made. A transaction can be created for the completed workflow, and a page status card can be created for the transaction.

In some embodiments, the workflow module 104 can provide, for example, a movie ticketing workflow. As an example, the movie ticketing workflow can provide a list of movies playing at a theater. A user can select a movie and a showing in order to buy tickets. The user can enter payment information. The movie ticketing workflow can be completed after a payment is successfully made. A transaction can be created for the completed workflow, and a page status card can be created for the transaction. All examples of workflows described herein are provided for illustrative purposes, and there can be many variations and other possibilities.

The page status card generation module 106 can generate page status cards. For example, the page status card generation module 106 can generate a page status card after a user completes a workflow associated with a page. The generated page status card can be provided on the page. Functionality of the page status card generation module 106 is described in more detail herein.

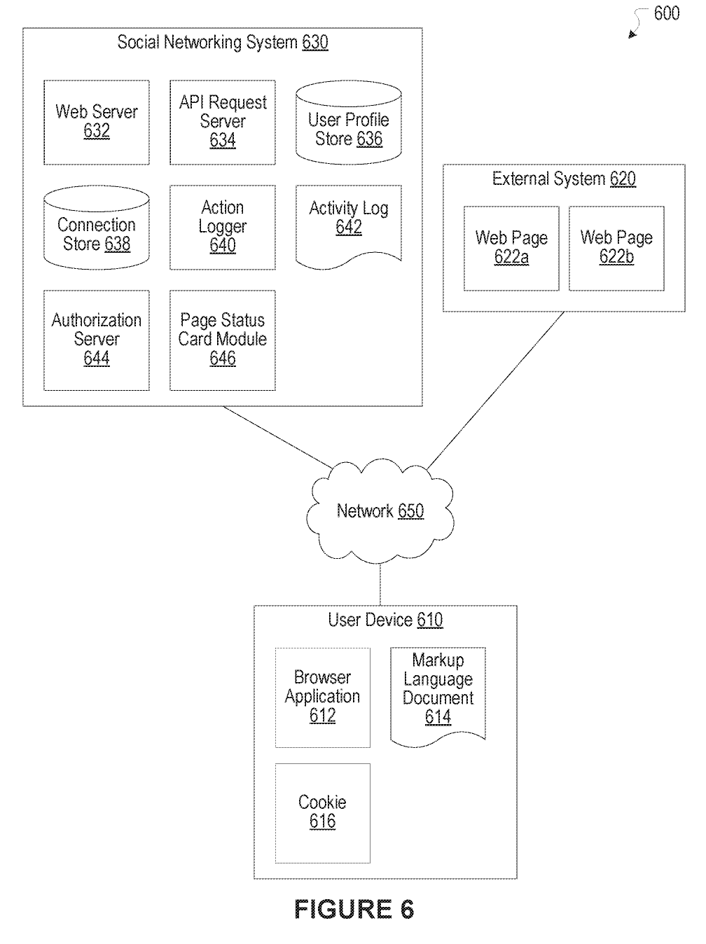

In some embodiments, the page status card module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the page status card module 102 can be, in part or in whole, implemented as software running on one or more computing devices or systems, such as on a server system or a client computing device. In some instances, the page status card module 102 can be, in part or in whole, implemented within or configured to operate in conjunction or be integrated with a social networking system (or service), such as a social networking system 630 of FIG. 6. Likewise, in some instances, the page status card module 102 can be, in part or in whole, implemented within or configured to operate in conjunction or be integrated with a client computing device, such as the user device 610 of FIG. 6. For example, the page status card module 102 can be implemented as or within a dedicated application (e.g., app), a program, or an applet running on a user computing device or client computing system. It should be understood that many variations are possible.

The data store 120 can be configured to store and maintain various types of data, such as the data relating to support of and operation of the page status card module 102. The data maintained by the data store 120 can include, for example, information relating to pages, page status cards, workflows, transactions, products, services, etc. The data store 120 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the page status card module 102 can be configured to communicate and/or operate with the data store 120. In some embodiments, the data store 120 can be a data store within a client computing device. In some embodiments, the data store 120 can be a data store of a server system in communication with the client computing device.

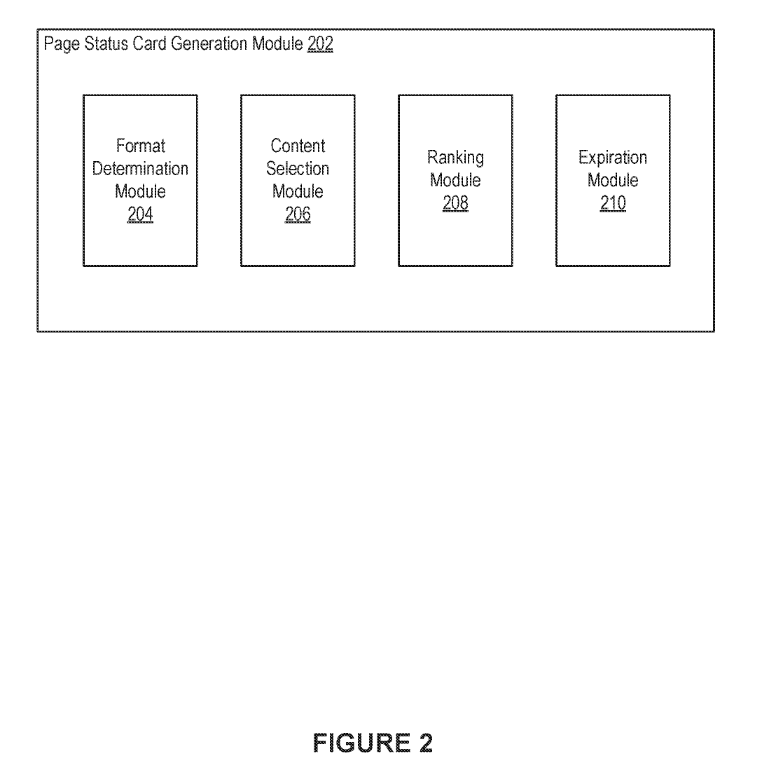

FIG. 2 illustrates an example page status card generation module 202 configured to generate page status cards, according to an embodiment of the present disclosure. In some embodiments, the page status card generation module 106 of FIG. 1 can be implemented with the example page status card generation module 202. As shown in the example of FIG. 2, the example page status card generation module 202 can include a format determination module 204, a content selection module 206, a ranking module 208, and an expiration module 210.

A page status card can include information about a transaction associated with the page status card. In some embodiments, content of a page status card can include a title, a description, a UI element for accessing additional details (“details UI element”), and one or more calls-to-action (CTAs). The details UI element, when selected, can provide a detailed view of a transaction in response to selection by a user. Information provided in response to selection of the details UI element can be referred to as “detailed view information.” In some cases, because a limited amount of information may be shown on a page status card itself, detailed view information can be used to provide additional details. For example, the details UI element can be a button, an icon, a link, etc. The CTAs can provide one or more actions that can be taken in connection with a workflow and/or a transaction associated with a page status card. In some embodiments, the details UI element can be provided in the form of a CTA since obtaining more details can be considered an action that can be taken in connection with a workflow and/or a transaction associated with a page status card. The content of a page status card can also include media content, such as an image, a video, an audio, etc. Many variations are possible. In some embodiments, the content of a page status card can include information relating to connections of a user associated with the page status card. The content of a page status card can be selected dynamically and can change over time. In some embodiments, there can be more than one page status card associated with the same workflow. For example, there can be two reservations for the same restaurant on different dates, and a different page status card corresponding to each reservation can be provided.

Page status cards can be provided on a page. For example, page status cards for a page can be displayed on a main user interface of the page. In some instances, page status cards can be organized as or in a page status card unit, and the page status card unit can be displayed on a page. A page status card unit can be scrolled, for example, horizontally or vertically, to view additional page status cards. Page status cards can be ranked based on various factors and can be displayed in a ranked order. As an example, a page status card relating to an event that is earlier in time can be shown first. In some embodiments, page status cards may expire after corresponding transactions are completed. As an example, a page status card for a movie ticket purchase expires after the end time of the movie and is no longer displayed on a page.

Page status cards may also be provided on surfaces other than a page. In some embodiments, page status cards can also be provided on a profile (page) of a user on a social networking system. For example, a user can choose to add page status cards to the user's profile. As another example, page status cards can automatically appear on the user's profile. In this example, a user can view page status cards for different pages on the user's profile. In certain embodiments, a user can choose to share one or more page status cards with other users. For example, a page status card displayed on a page or a user's profile can have a CTA button or a menu item for sharing the page status card with one or more other users. In these embodiments, a shared page status card can appear in a feed (e.g., a newsfeed) of other users. Many variations are possible.

The format determination module 204 can determine a format or template for creating a page status card. Page status cards for different workflows can include different types of information about corresponding transactions. Accordingly, a format can specify information to be included in a page status card for a particular workflow. For example, a format can specify content of a page status card. As described above, the content of a page status card can include a title, a description, a details UI element, a CTA, media content, information associated with connections of a user associated with the page status card, etc. A format can also specify a layout of a page status card. For example, the layout can indicate a visual arrangement of various parts of the content of a page status card. A format can further specify detailed view information to be provided in response to selection of a details UI element. In certain embodiments, a format of a page status card can change over time, for example, according to various stages of a transaction. In these embodiments, a format for a page status card can specify information to be included in a page status card at different stages. In some embodiments, a format for a page status card can be defined by an entity associated with a page or a third party associated with a workflow. For example, a format can be specified by using an application programming interface (API).

In one example, a format of a page status card for a food delivery workflow can be specified as follows. The title of the page status card can indicate “Your Order.” As an example, the description of the page status card can indicate “Your order was sent to Restaurant A. It should arrive between 2:00-2:15 pm,” where “Restaurant A” is the name of a restaurant and “2:00-2:15 pm” is an estimated delivery time window. The format can include a details UI element or a CTA for accessing additional details about the transaction. The format can include one or more CTAs associated with the food delivery workflow and/or the transaction. For example, a CTA for the food delivery workflow can be a “reorder” CTA. The format can further specify detailed view information for the food delivery workflow and/or the transaction. For example, the detailed view information can include ordered menu items, contact information, and payment information.

In another example, a format of a page status card for a restaurant reservation workflow can be specified as follows. The title of the page status card can indicate “Your Reservation.” The description of the page status card can indicate a date and time for a reservation. The format can also include a details UI element or a CTA for accessing additional details about the transaction. The format can include one or more CTAs associated with the restaurant reservation workflow and/or the transaction. For example, a CTA for the restaurant reservation workflow can be a “get directions” CTA. The format can further specify that detailed view information for the restaurant reservation workflow includes restaurant information, contact information, and payment information. In certain embodiments, the page status card can be provided as or include a calendar view.

In yet another example, a format of a page status card for a movie ticketing workflow can be specified as follows. The title of the page status card can indicate “Your Movie.” The format can include a code (e.g., a barcode, a QR code, etc.) that can be scanned at the theater. The format can also include a details UI element or a CTA for accessing additional details about the transaction. The format can include one or more CTAs associated with the movie ticketing workflow and/or the transaction. For example, a CTA for the movie ticketing workflow can be a “write a review” CTA. The format can further specify that detailed view information for the movie ticketing workflow and/or the transaction includes theater information, contact information, and payment information. In certain embodiments, the page status card can be provided as or include a calendar view.

The content selection module 206 can dynamically determine content of a page status card. A page status card for a transaction resulting from a particular workflow can be created based on a format associated with the particular workflow, for example, as determined by the format determination module 204. Content of a page status card can change based on various factors, such as time, a surface on which the page status card is provided, a user who is viewing the page status card, etc. Accordingly, the content selection module 206 can dynamically determine the content of a page status card based on the various factors.

In some embodiments, the content of a page status card can vary based on time. For instance, a CTA for a page status card can change over time, for example, based on a status or a progress of a transaction associated with the page status card. As an example, for the food delivery workflow, a CTA of a page status card can initially relate to modifying an order or contacting a restaurant, and the CTA can change to reordering the same menu items after the food is delivered. As another example, for the restaurant reservation workflow, a CTA for a page status card can initially relate to modifying or canceling a reservation, and the CTA can change to “get directions” when a current time is close to a reservation time. Other parts of the content of a page status card can also change over time, such as the description or media content. As an example, for the movie ticketing workflow, media content of a page status card can initially show a map of a theater showing a movie, and the media content can change closer to a start time for the movie to showing a QR code that represents a ticket for the movie. Many variations are possible.

In certain embodiments, the content of a page status card can vary based on a surface on which the page status card is provided. For instance, a page status card can be provided on a page, on a profile of a user, or in a feed of other users. A page status card can include different CTAs or a different number of CTAs depending on whether the page status card is provided on a page, on a profile of a user, or in a feed of other users. As an example, a page status card on a profile of a user may include a CTA for sharing the page status card with other users, whereas a page status card on a page may not include such CTA. As another example, a page status card can include a first CTA when provided on a profile of a user associated with the page status card and include a different second CTA when provided in a feed of other users. In some embodiments, a page status card can be provided in a user's own feed after sharing the page status card, and the content of the page status card may also vary depending on whether the page status card is provided in the user's feed.

In some embodiments, the content of a page status card can vary based on a user who is viewing the page status card. At least some information relating to a transaction that is available to a user associated with the page status card may not be available to another user. Accordingly, actions that can be taken and/or an amount of detail relating to a transaction available to a user can vary depending on whether the user is associated with the page status card or not. As an example, if a user buys a movie ticket and shares a page status card for the transaction with the user's connections, a CTA of the page status card for the user can be “get directions,” whereas a CTA of a shared page status card appearing in another user's feed can be “buy tickets.” In this example, the CTA “buy tickets” in the other user's feed can allow the other user to initiate the movie ticket workflow. As another example, the page status card for the user can include a details UI element or a CTA for accessing additional details, but the shared page status card may not include the details UI element or the CTA for accessing additional details.

In certain embodiments, the content of a page status card can include information associated with connections of a user associated with the page status card. For instance, information associated with connections of a user can include which of the user's connections have entered into transactions with the same page, are attending an event associated with a page status card, etc. As an example, if a page status card relating to a user is associated with the movie ticketing workflow, the page status card can include information about one or more connections of the user who are attending the same movie showing. For instance, the page status card can indicate names and/or numbers of connections attending the same movie showing. In some instances, the page status card can also include profile images of one or more connections. Many variations are possible.

The ranking module 208 can rank page status cards based on various factors. Multiple page status cards can be provided on a surface, and the ranking module 208 can rank the page status cards to determine an order in which they should be provided. Examples of factors for ranking page status cards can include time, preferences of a user, activities by connections of a user, advertising, etc. The ranking module 208 can rank page status cards based on one or more of the factors. As an example, page status cards can be ranked based on times associated with the page status cards. For instance, if a first page status card is for a food delivery for today and a second page status card is for a reservation next week, the first page status card can be ranked higher than the second page status card. As another example, page status cards can be ranked based on preferences of a user associated with the page status cards. For instance, if the user has indicated a preference for food deliveries over reservations, page status cards for food deliveries can be ranked higher than page status cards for reservations. In some instances, the user's preferences can be inferred, for example, based on historical data. As an additional example, page status cards can be ranked based on activities by connections of a user. For instance, if a user's connections have engaged in transactions similar to a transaction associated with a particular page status card, the particular page status card can be ranked higher than other page status cards. As a further example, page status cards can be ranked based on whether a page status card includes advertising. For instance, page status cards can be a surface for providing advertising, and an advertisement can be provided in a page status card. A page status card including advertising can be ranked higher than a page status card not including advertising. Many variations are possible.

In some embodiments, the ranking module 208 can rank page status cards based on machine learning techniques. The ranking module 208 can train a machine learning model to rank page status cards. For example, a machine learning model can be trained based on training data (e.g., labeled data) including page status cards and associated rankings. For instance, the training data can include sets of page status cards and corresponding rankings of page status cards within the sets. The training data can include various features. For example, features can relate to the factors for ranking page status cards, such as time, preferences of a user, activities by connections of a user, and advertising. The machine learning model can determine weights associated with various features used to train the machine learning model. The ranking module 208 can apply the trained machine learning model to determine rankings for page status cards to be provided on a surface. For example, the trained machine learning model can output a ranking or a score for a particular page status card, and page status cards can be ordered based on respective rankings or scores.

The expiration module 210 can determine when to expire a page status card. An expired page status card is no longer displayed on a surface. Expiration of a page status card can be determined based on various factors, such as time and specified criteria. For instance, a page status card can expire at or after completion of a transaction associated with the page status card. In some instances, a page status card can expire at or after an occurrence of an event associated with the page status card, at or after a start time associated with the event, or at or after an end time associated with the event. In some embodiments, a page status card may expire after a predetermined amount of time passes after completion of a transaction associated with the page status card or after an event associated with the page status card. A page status card may continue to be provided after completion of a transaction or after an event such that a corresponding workflow can be reinitiated and/or a follow-up action can be taken. As an example, in the food delivery workflow, a page status card can expire a predetermined amount of time after completion of the food delivery, and a CTA of the page status card can be “reorder” after the completion of the food delivery. As another example, in the movie ticketing workflow, a page status card can expire a predetermined amount of time after the end time of the movie, and a CTA of the page status card can be “write a review” or “rate the movie.” In some embodiments, page status cards do not automatically expire and are provided until a user chooses to close or dismiss the page status cards.

In some embodiments, the expiration module 210 can determine expiration of page status cards to be the same across surfaces. In other embodiments, the expiration module 210 can vary expiration of page status cards based on a surface on which the page status card is provided. For instance, page status cards can expire more quickly when provided on one surface than when provided on another surface. In some instances, page status cards can expire when provided on one surface, whereas page status cards do not expire when provided on another surface. As an example, a page status card provided on a page can expire after a transaction associated with the page status card is completed, whereas a page status card provided on a user's profile does not expire or may expire later than on a page. As another example, a page status card provided in a user's feed may expire more quickly than a page status card provided on a page or a user's profile. Many variations are possible. All examples herein are provided for illustrative purposes, and there can be many variations and other possibilities.

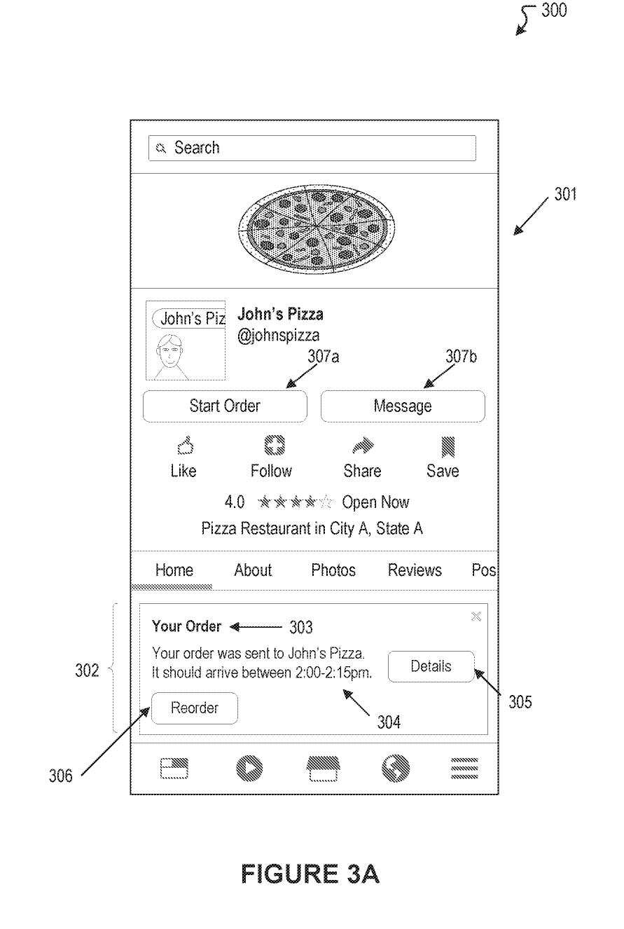

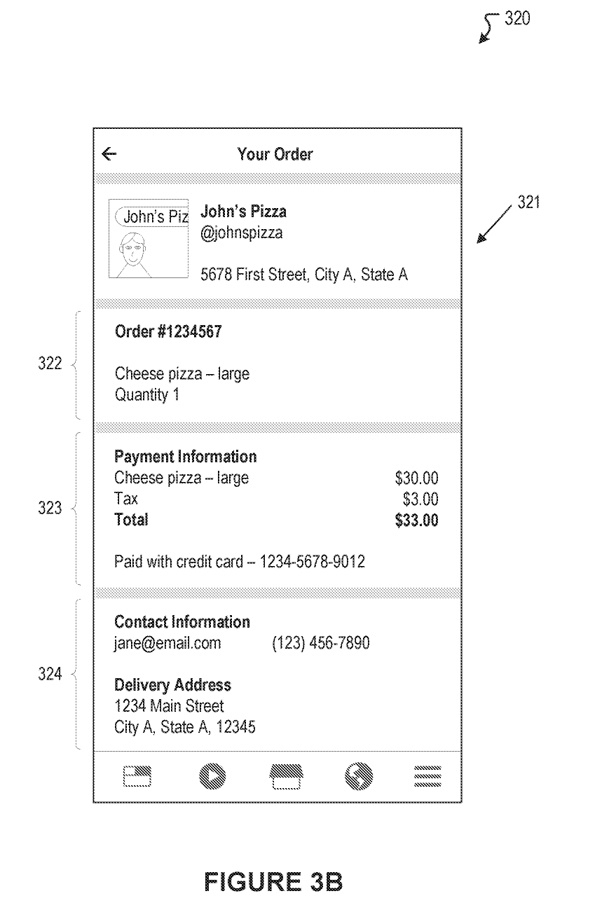

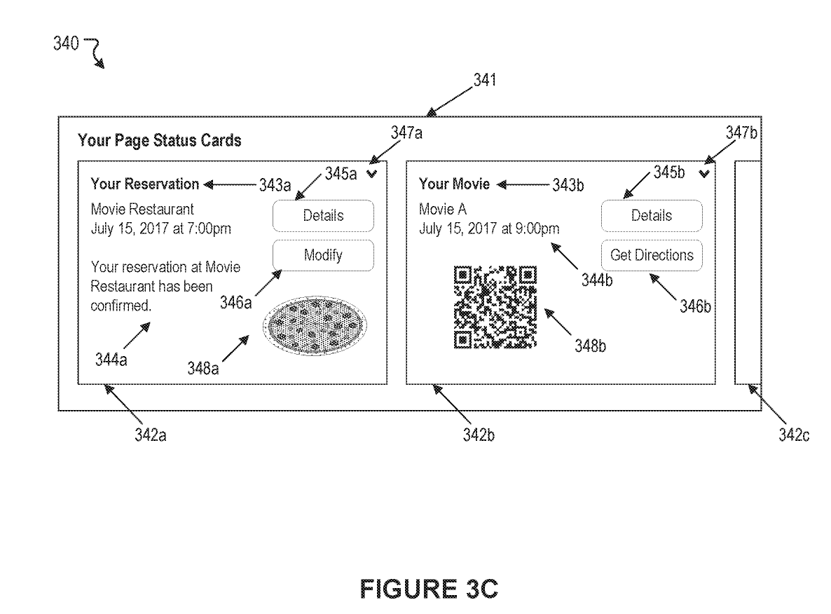

FIG. 3A illustrates an example user interface 300 for providing page status cards, according to an embodiment of the present disclosure. In the example of FIG. 3A, the user interface 300 displays a page 301 of a restaurant. The page 301 can provide one or more CTA buttons, such as a “Start Order” CTA button 307a and a “Message” CTA button 307b. A workflow for ordering food can be initiated in response to a user selecting the CTA button 307a. After the user completes the workflow for ordering food, a transaction can be created for the order. A page status card 302 for the transaction can be generated by the page status card module 102, as discussed herein. The page status card 302 can be provided on the page 301. In the example of FIG. 3A, the page status card 302 includes a title 303, a description 304, a details button 305, and a CTA button 306. A CTA of a page status card can be provided as a UI element, such as a button, an icon, a link, etc. FIG. 3B illustrates an example user interface 320 for providing page status cards, according to an embodiment of the present disclosure. In the example of FIG. 3B, the user interface 320 displays a detailed view 321 of the transaction associated with the page status card 302 in FIG. 3A after selection of the details button 305. In the example of FIG. 3B, the detailed view 321 includes an order summary 322, payment information 323, and contact information 324. For example, the contact information 324 can include a delivery address. All examples herein are provided for illustrative purposes, and there can be many variations and other possibilities.

FIG. 3C illustrates an example page status card unit 340 for providing page status cards, according to an embodiment of the present disclosure. In some embodiments, one or more page status cards can be organized in or provided in a page status card unit. In the example of FIG. 3C, the page status card unit 340 includes multiple page status cards, including page status cards 342a, 342b, 342c. The page status card unit 340 can be provided on a page. For instance, in the example of FIG. 3A, the page status card 302 can be included in a page status card unit, and the page status card unit can be provided on the page 301. The page status card unit 340 can be scrolled horizontally, for example, to the right, in order to show additional page status cards. The page status cards 342a, 342b, 342c are shown horizontally in the example of FIG. 3C for illustrative purposes, and the page status cards 342a, 342b, 342c can be provided in any suitable arrangement or layout. When multiple page status cards are included in a page status card unit, the page status cards can be ranked and provided in an order of the ranking. For example, the page status cards 342a, 342b, 342c are displayed in an order in which they are ranked. The page status cards 342a, 342b, 342c can be ranked by the page status card module 102, as described above. In some embodiments, the page status card unit 340 can include more than one page status card for the same workflow. For example, there can be two reservations for the same restaurant on different dates, and a different page status card corresponding to each reservation can be provided.

In the example shown, the page status card 342a is a page status card resulting from completion of a restaurant reservation workflow relating to a restaurant. The page status card 342a includes a title 343a, a description 344a, a details button 345a, and a CTA button 346a. The page status card 342a can also include an image 348a. In the example of FIG. 3C, the image 348a is an image associated with the restaurant. The page status card 342b is a page status card resulting from completion of a movie ticketing workflow to obtain a movie ticket. The page status card 342b includes a title 343b, a description 344b, a details button 345b, and a CTA button 346b. The page status card 342b can also include an image 348b. In the example of FIG. 3C, the image 348b is an image of a QR code for the movie ticket. Content of the page status card 342c is not shown in FIG. 3C, but the page status card 342c can be associated with a particular workflow. Content of the page status cards 342a, 342b, 342c can be determined dynamically, by the page status card module 102, as described above. The page status cards 342a, 342b, 342c can also include a menu or a UI element for sharing the page status cards 342a, 342b, 342c with other users. In the example of FIG. 3C, the page status cards 342a, 342b include respective elements 347a, 347b that can be selected to access an option to share the page status cards 342a, 342b. All examples herein are provided for illustrative purposes, and there can be many variations and other possibilities.

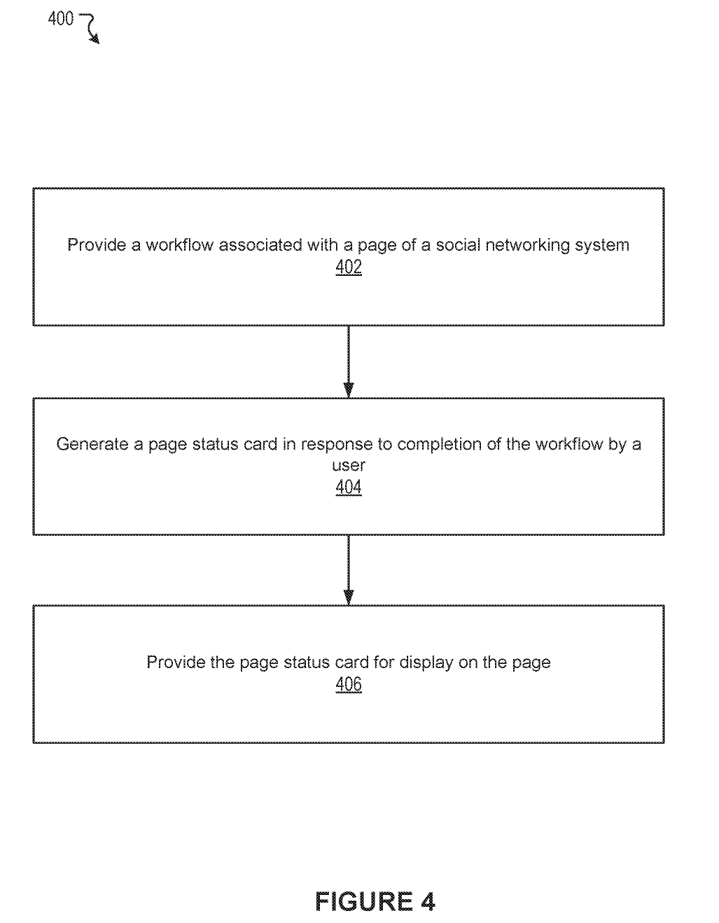

FIG. 4 illustrates an example first method 400 for providing page status cards, according to an embodiment of the present disclosure. It should be understood that there can be additional, fewer, or alternative steps performed in similar or alternative orders, or in parallel, based on the various features and embodiments discussed herein unless otherwise stated.

At block 402, the example method 400 can provide a workflow associated with a page of a social networking system. At block 404, the example method 400 can generate a page status card in response to completion of the workflow by a user. At block 406, the example method 400 can provide the page status card for display on the page. Other suitable techniques that incorporate various features and embodiments of the present disclosure are possible.

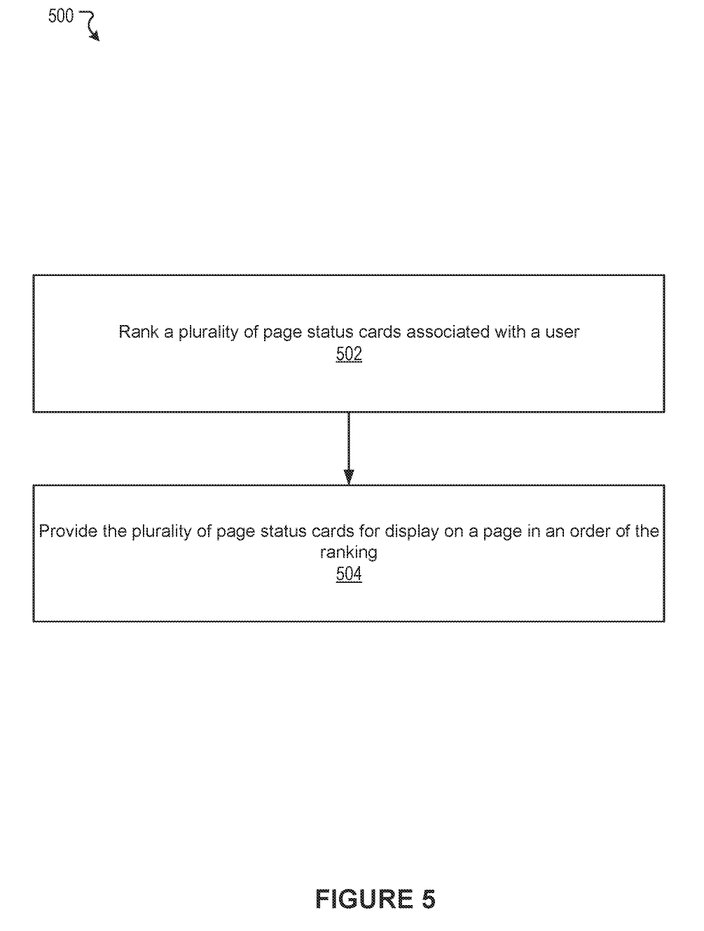

FIG. 5 illustrates an example second method 500 for providing page status cards, according to an embodiment of the present disclosure. It should be understood that there can be additional, fewer, or alternative steps performed in similar or alternative orders, or in parallel, based on the various features and embodiments discussed herein unless otherwise stated. Certain steps of the method 500 may be performed in combination with the example method 400 explained above.

At block 502, the example method 500 can rank a plurality of page status cards associated with a user. At block 504, the example method 500 can provide the plurality of page status cards for display on a page in an order of the ranking. The page can be similar to the page explained in connection with FIG. 4. Other suitable techniques that incorporate various features and embodiments of the present disclosure are possible.

It is contemplated that there can be many other uses, applications, features, possibilities, and/or variations associated with various embodiments of the present disclosure. For example, users can, in some cases, choose whether or not to opt-in to utilize the disclosed technology. The disclosed technology can, for instance, also ensure that various privacy settings, preferences, and configurations are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a page status card module 646. The page status card module 646 can be implemented with the page status card module 102, as discussed in more detail herein. In some embodiments, one or more functionalities of the page status card module 646 can be implemented in the user device 610.

### Hardware Implementation

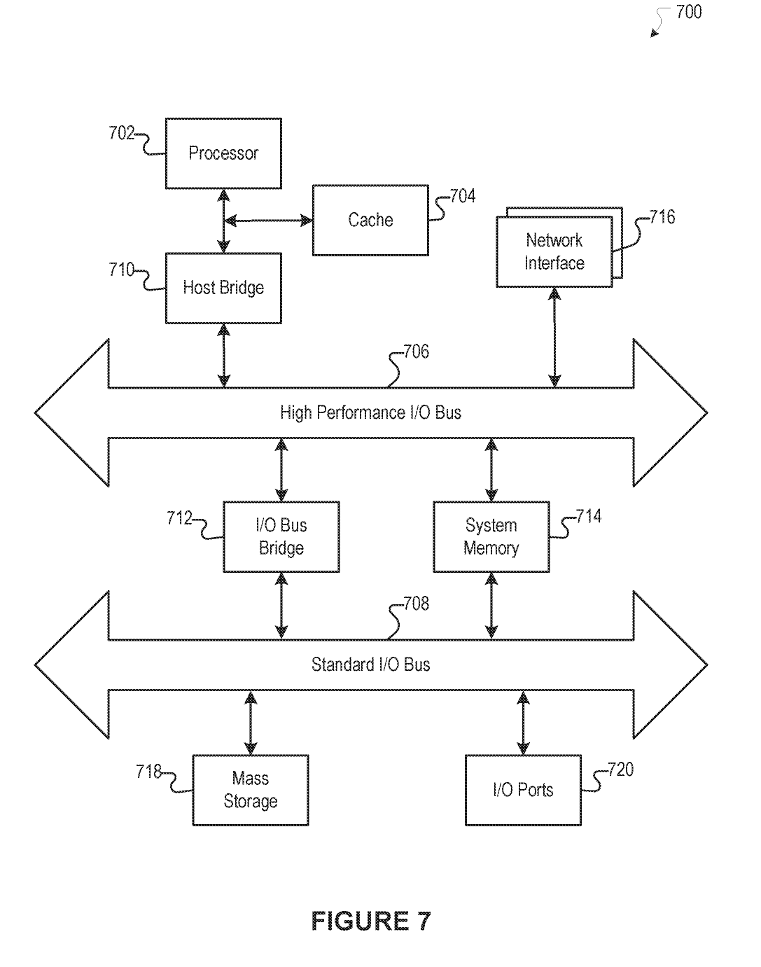

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
providing, by a computing system, a workflow associated with a page of a social networking system;
generating, by the computing system, a page status card in response to completion of the workflow by a user; and
providing, by the computing system, the page status card for display on the page.

2. The computer-implemented method of claim 1, further comprising:
ranking a plurality of page status cards associated with the user; and
providing the plurality of page status cards for display on the page in an order of the ranking.

3. The computer-implemented method of claim 2, wherein the ranking the plurality of page status cards is based on a machine learning model.

4. The computer-implemented method of claim 1, wherein the workflow includes one or more of: a delivery workflow, a reservation workflow, or a ticketing workflow.

5. The computer-implemented method of claim 1, further comprising determining an expiration of the page status card, wherein the page status card is no longer provided for display on the page after the expiration of the page status card.

6. The computer-implemented method of claim 1, wherein content of the page status card includes one or more of: a title, a description, a call-to-action (CTA), a user interface (UI) element for accessing additional details associated with the page status card, or media content.

7. The computer-implemented method of claim 6, wherein the content of the page status is dynamically determined.

8. The computer-implemented method of claim 1, wherein a format of the page status card is specified by an application programming interface (API).

9. The computer-implemented method of claim 1, further comprising providing the page status card on a profile of the user.

10. The computer-implemented method of claim 1, wherein the page status card is shared by the user with at least one connection of the user, and wherein the page status card is provided in a feed of the at least one connection of the user.

11. A system comprising:
at least one hardware processor; and
a memory storing instructions that, when executed by the at least one processor, cause the system to perform:
providing a workflow associated with a page of a social networking system;
generating a page status card in response to completion of the workflow by a user; and
providing the page status card for display on the page.

12. The system of claim 11, wherein the instructions further cause the system to perform:
ranking a plurality of page status cards associated with the user; and
providing the plurality of page status cards for display on the page in an order of the ranking.

13. The system of claim 11, wherein the instructions further cause the system to perform determining an expiration of the page status card, wherein the page status card is no longer provided for display on the page after the expiration of the page status card.

14. The system of claim 11, wherein content of the page status card includes one or more of: a title, a description, a call-to-action (CTA), a user interface (UI) element for accessing additional details associated with the page status card, or media content.

15. The system of claim 14, wherein the content of the page status is dynamically determined.

16. A non-transitory computer readable medium including instructions that, when executed by at least one hardware processor of a computing system, cause the computing system to perform a method comprising:
providing a workflow associated with a page of a social networking system;
generating a page status card in response to completion of the workflow by a user; and
providing the page status card for display on the page.

17. The non-transitory computer readable medium of claim 16, wherein the method further comprises:
ranking a plurality of page status cards associated with the user; and
providing the plurality of page status cards for display on the page in an order of the ranking.

18. The non-transitory computer readable medium of claim 16, wherein the method further comprises determining an expiration of the page status card, wherein the page status card is no longer provided for display on the page after the expiration of the page status card.

19. The non-transitory computer readable medium of claim 16, wherein content of the page status card includes one or more of: a title, a description, a call-to-action (CTA), a user interface (UI) element for accessing additional details associated with the page status card, or media content.

20. The non-transitory computer readable medium of claim 19, wherein the content of the page status is dynamically determined.
